(19) United States
(12) Patent Application Publication
(10) Pub. No.: US 2026/0168634 A1
(43) Pub. Date: Jun. 18, 2026

(54) HEADLAMP FOR A MOTOR VEHICLE

(71) Applicant: HELLA GMBH & CO. KGAA, Lippstadt (DE)

(72) Inventors: Martin Vollmer, Anröchte (DE); Dirk Sossenheimer, Lippstadt (DE)

(21) Appl. No.: 19/125,432

(22) PCT Filed: Oct. 31, 2022
(86) PCT No.: PCT/EP2022/080380

§ 371 Date: Apr. 29, 2025

(51) Int. Cl. F21S 41/143; F21S 41/20; F21S 41/24; F21S 41/265; F21S 41/40; F21S 43/14; F21S 43/40; F21S 45/47; F21W 102/13; F21W 103/10; F21W 103/55

(52) U.S. Cl. CPC F21S 41/143; F21S 41/24; F21S 41/265; F21S 41/285; F21S 41/40; F21S 43/14; F21S 43/40; F21S 45/47; F21W 2102/13; F21W 2103/10; F21W 2103/55

(57) ABSTRACT

Headlamp for a motor vehicle, including at least one first light source, at least one aperture stop, a primary optics, and a secondary optics, wherein the headlamp is arranged such that the light emanating from the at least one first light source passes at least partially through the aperture stop, the primary optics and the secondary optics in succession to produce a main light function, and wherein the headlamp includes at least one second light source and is arranged such that the light emanating from the at least one second light source passes at least partially through the primary optics and/or the secondary optics for generating a signal light function.

### CROSS-REFERENCE TO RELATED APPLICATIONS

This application is the National Stage of International Application No. PCT/EP 2022/080380 filed on Oct. 31, 2022, the disclosure of which is hereby incorporated by reference in its entirety.

### BACKGROUND

The present invention relates to a headlamp for a motor vehicle.

A headlamp of the aforementioned type is known from DE 10 2020 102 226 A1. The headlamp described therein comprises a light source, in particular in the form of a light emitting diode (LED), from which light is emitted during operation of the headlamp. The headlamp further comprises primary optics in the form of collimating optics having an entrance surface and an exit surface through which the light emitted by the light source passes. The headlamp further comprises secondary optics configured as projection optics having a first array of lenses and a second array of lenses, wherein light emanating from the collimation optics passes first through the first array of lenses and then through the second array of lenses. The headlamp further comprises an aperture stop disposed in front of the collimating optics through which light emanating from the light source passes.

In such a headlamp, the appearance of the headlamp from the outside is not homogeneous. In particular, the exit surface of the headlamp, which is realized for example by the secondary optics or an additional cover sheet, is not homogeneously illuminated by the main light function, especially by the low beam distribution and/or the high beam distribution. Furthermore, in a headlamp of this type, additional modules must be provided for signal light functions such as daytime running light and position light. As a result, the daytime and nighttime appearance of the headlamp is different. A further disadvantage of separate modules is that additional circuit boards and heat sinks must be provided for the light emitting diodes of the signal light function.

### SUMMARY

The object of the present invention is to provide a headlamp of the type mentioned at the beginning which has a more homogeneous external appearance during operation, the daytime and nighttime appearances differing as little or not at all as possible.

According to the invention, this is achieved by a headlamp of the type mentioned at the beginning with embodiments of the invention.

According to one embodiment, the headlamp comprises at least one second light source and is arranged such that the light emitted by the at least one second light source passes at least partially through the primary optics and/or the secondary optics for generating a signal light function. By utilizing the primary optics and/or the secondary optics, the signal light function can contribute to the external appearance of the headlamp. This can both increase the homogeneity of the external appearance and reduce the differences between daytime and nighttime appearances. In particular, the light emitted by the second light sources can illuminate the secondary optics or an additional cover sheet of the headlamp comparatively homogeneously by passing through the secondary optics.

It may be provided that the primary optics comprise at least one lens for imaging the aperture stop into the exterior of the motor vehicle, the lens preferably being a collimating lens. In this regard, the headlamp may be arranged such that light emanating from the at least one first light source passes through the at least one lens for generating a main light function, and such that light emanating from the at least one second light source passes at least partially through the at least one lens for generating a signal lighting function. Thus, the collimating lens may contribute to the generation of the signal light function.

It is possible for the secondary optics to comprise a cylindrical lens array. In this case, the cylindrical axes of the cylindrical lenses of the cylindrical lens array may be oriented vertically when the headlamp is installed in a motor vehicle. This design means that light passing through the cylindrical lens array is expanded in the horizontal direction and thus the illumination in the exterior of the motor vehicle can be controlled in a targeted manner in the horizontal direction.

It may be provided that the headlamp is arranged for light emanating from the at least one first light source to pass through the cylindrical lens array to produce a main light function, and for light emanating from the at least one second light source to pass at least partially through the cylindrical lens array to produce a signal light function. Thus, the cylindrical lens array may contribute to the generation of the signal light function.

It is possible that the at least one first light source is a light emitting diode arranged on a printed circuit board and/or that the at least one second light source is a light emitting diode arranged on a printed circuit board. In this case, the at least one first light source configured as a light-emitting diode and the at least one second light source configured as a light-emitting diode can be arranged on a common printed circuit board. As a result, there is no need to provide an additional printed circuit board for the light emitting diodes of the signal light function, so that the costs for manufacturing the head-lamp can be reduced.

It may be provided that the headlamp comprises a heat sink associated with the at least one first light source and/or that the headlamp comprises a heat sink associated with the at least one second light source. In this regard, the heat sink associated with the at least one first light source and the heat sink associated with the at least one second light source may be identical. As a result, no additional heat sink needs to be provided for the light emitting diodes of the signal light function, so that the costs for manufacturing the headlamp can be further reduced.

It is possible that the headlamp comprises at least one light guide having an entrance surface and an exit surface, the headlamp being arranged for the light emitted by the at least one second light source to enter the entrance surface of the at least one light guide, to exit the exit surface of the at least one light guide, and to subsequently pass at least partially through the primary optics and/or the secondary optics. Through the light guide, the light required for the signal function can be selectively guided to the primary optics and/or the secondary optics.

It may be provided that the headlamp is arranged for the light to emerge from the at least one second light source in a direction towards the entrance surface of the at least one light guide. Alternatively, it may be provided that the headlamp comprises at least one reflecting surface, the headlamp being arranged for the light to emerge from the at least one second light source in the direction of the at least one reflecting surface and to be reflected by the at least one reflecting surface onto the entrance surface of the at least one light guide or onto the secondary optics. Both alternatives can ensure that the light required for the signal function is guided specifically to the primary optics and/or the secondary optics.

The main light function can be a high beam and/or a low beam. Furthermore, the signal light function can be a daytime running light and/or a position light.

### BRIEF DESCRIPTION OF THE DRAWINGS

With reference to the accompanying drawings, the invention is explained in more detail below. Thereby shows:

FIG. 1 a schematic top view of a first embodiment of a headlamp according to the invention;

FIG. 2 a schematic front view of the headlamp according to FIG. 1;

FIG. 3 a schematic top view of a second embodiment of a headlamp according to the invention;

FIG. 4 a schematic front view of the headlamp according to FIG. 3;

FIG. 5 a schematic top view of a third embodiment of a headlamp according to the invention;

FIG. 6 a schematic top view of a fourth embodiment of a headlamp according to the invention;

FIG. 7 a schematic top view of a fifth embodiment of a headlamp according to the invention;

FIG. 8a a schematic front view of a first embodiment of an aperture stop of a head-lamp according to the invention;

FIG. 8b A schematic front view of a second embodiment of an aperture stop of a headlamp according to the invention; and

FIG. 8c A schematic front view of a third embodiment of an aperture stop of a head-lamp according to the invention.

### DETAILED DESCRIPTION

In the figures, identical and functionally identical parts are given the same reference signs.

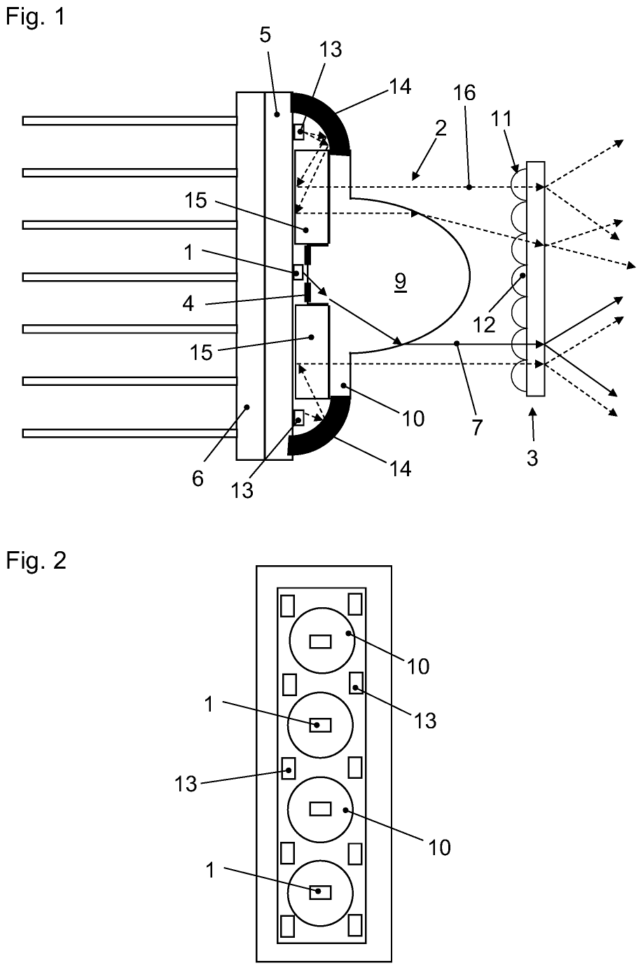

The embodiment of a headlight according to the invention shown in FIG. 1 and FIG. 2 comprises four first light sources 1 which are arranged one below the other when installed in the motor vehicle (see FIG. 2). The headlamp further comprises a primary optics 2 and a secondary optics 3 as well as four aperture stops 4 arranged between the light sources 1 and the primary optics 2.

It is quite possible that more or less than four first light sources 1 are arranged one above the other. It is also possible that several first light sources 1 are arranged next to each other. Accordingly, it is also possible that more or less than four aperture stops 4 are arranged one above the other. Furthermore, it is also possible that several aperture stops 4 are arranged next to each other.

The first light sources 1 are in the form of light emitting diodes (LEDs) arranged on a printed circuit board 5. A heat sink 6 is connected to the circuit board 5, which can dissipate the heat generated by the first light sources 1 in the form of light emitting diodes.

The aperture stops 4 can suitably shape the light 7 emitted by the first light sources 1 (see the solid lines in FIG. 1). For this purpose, they have aperture openings 8 through which part of the light 7 emitted by the light sources 1 can pass. Each of the first light sources 1 is associated with one of the aperture stops 4 in such a way that the light 7 emanating from one of the first light sources 1 passes through the aperture opening 8 of the associated aperture stop 4.

FIG. 8a to FIG. 8c show examples of typical aperture stops 4 with aperture openings 8 that are particularly suitable for generating a low beam distribution. For example, FIG. 8a shows an aperture stop 4 for a so-called Z-beam. FIG. 8b shows an aperture stop 4 for a prefield. FIG. 8c shows an aperture stop 4 for a so-called kink light distribution.

The primary optics 2 has four lenses 9 arranged one above the other. The lenses 9 may be designed as collimating lenses. The lenses 9 have a circumferential edge 10 which, in the first embodiment, is formed essentially as a plane-parallel plate. It is quite possible that the circumferential edge 10 has inclined surfaces.

The lenses 9 are each associated with one of the first light sources 1 and one of the aperture stops 4 such that the light 7 emitted from one of the first light sources 1 and passing through the aperture opening 8 of the associated aperture stop 4 passes through the associated lens 9. The lenses 9 can image the associated aperture stop 4 into the exterior of the motor vehicle.

In particular, the first light sources 1 are each arranged directly in front of the aperture stop 4, with the aperture stop 4 being arranged directly in front of the lens 9 in each case. The first light sources 1 are thus arranged centrally behind the lenses 9 in the front view according to FIG. 2.

The secondary optics 3 has a cylindrical lens array 11 that is arranged on the side of the secondary optics 2 facing the primary optics 2. The cylindrical lenses 12 of the cylindrical lens array 11 are arranged side by side in the horizontal direction when installed in the motor vehicle, with the cylinder axes extending in the vertical direction. The light 8 emitted from the lenses 9 of the primary optics 2 impinges on the cylindrical lenses 12 and is expanded by them in the horizontal direction.

The first light sources 1, the primary optics 2, the secondary optics 3 and the aperture stops 4 serve to generate a main light function of the headlamp. The main light function is in particular a high beam and/or a low beam.

The first embodiment of the headlamp further comprises ten second light sources 13 which, when installed in the motor vehicle, are arranged next to one another in two rows spaced apart from one another (see FIG. 2). In each of these two rows, five second light sources 13 are arranged one below the other. The individual second light sources 13 are offset outwards relative to the first light sources 1.

It is quite possible that more or less than ten second light sources 13 are arranged one above the other. It is also possible that the second light sources 13 form only one row or that more than two rows of second light sources 13 are arranged next to each other.

The second light sources 13 are in the form of light emitting diodes arranged on the same printed circuit board 5 as the first light sources 1. Thus, the heat sink 6 is associated with both the first light sources 1 and the second light sources 13, so that the heat sink 6 can also dissipate the heat generated by the second light sources 13.

The second light sources 13 are arranged in an outer region of the circuit board 5. The headlight comprises a plurality of reflecting surfaces 14 and a plurality of light guides 15. The light guides 15 each extend inwardly from one of the second light sources 13 toward the aperture stops 4. In each case, one of the reflecting surfaces 14 is arranged in front of one of the second light sources 13 such that the light 16 emitted from the second light source 13 (see the dashed lines in FIG. 1) is reflected onto the outwardly facing end surface of the light guide 15.

Light 16 emerges from the light guide 15 in the direction of the primary optics 2. The light 16 then passes through the primary optics 2 and the secondary optics 3. As it passes through the primary optics 2, portions of the light 16 pass through curved portions of the lens 9 and other portions of the light 16 pass through the circumferential edge 10 of the lens 9. In this process, the light 16 emanating from the secondary light sources 13 can illuminate the secondary optics 3 or even an additional cover sheet of the headlamp, which is not shown, in a comparatively homogeneous manner.

The second light sources 13, the primary optics 2 and/or the secondary optics 3 serve to generate a signal light function of the headlamp. The signal light function is in particular a daytime running light and/or a position light.

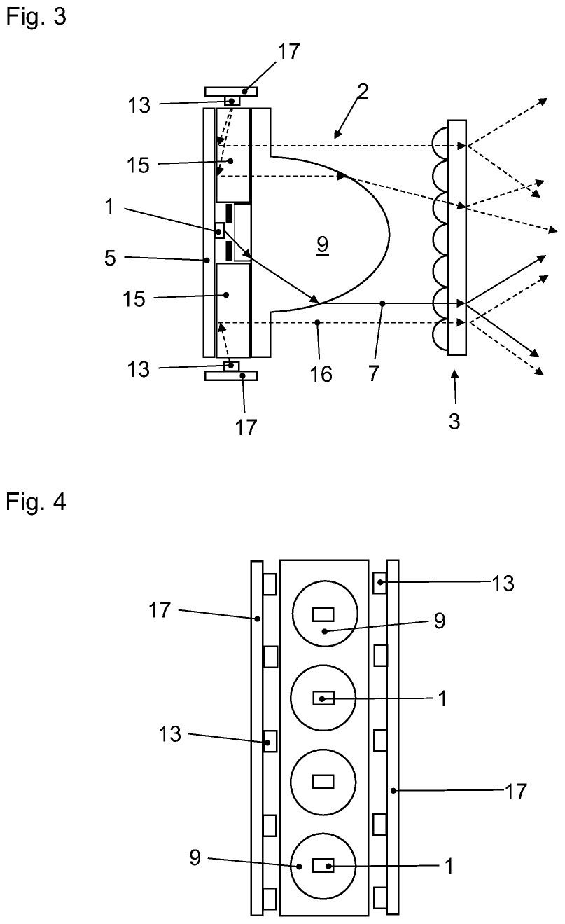

The second embodiment according to FIG. 3 and FIG. 4 differs from the first embodiment in that the second light sources 13 are mounted on two separate printed circuit boards 17. The printed circuit boards 17 and the second light sources 13 are arranged in such a way that the light 16 emitted by the second light sources 13 is emitted directly in the direction of the light guides 15. The reflecting surfaces 14 are therefore not required in this embodiment.

In the third embodiment according to FIG. 5, the first and second light sources 1, 13 are arranged on the same printed circuit board 5 (not shown in FIG. 5). In contrast to the first embodiment, the light guides 15 do not extend from the outside to the inside, but from the second light sources 13 to the right in FIG. 5 in the direction of the secondary optics 3. The light 16 emanating from the second light sources 13 can be coupled into the front side of the respectively assigned light guide 15, whereby the outer side of the light guide 15 can be mirrored in each case in order to prevent the light 16 from being coupled out to the outside. The light 16 is coupled out of the light guide 15 inwardly directly in the direction of the secondary optics 3. Thus, the light 16 emitted from the secondary light sources 13 does not pass through the primary optics 2 in this embodiment example.

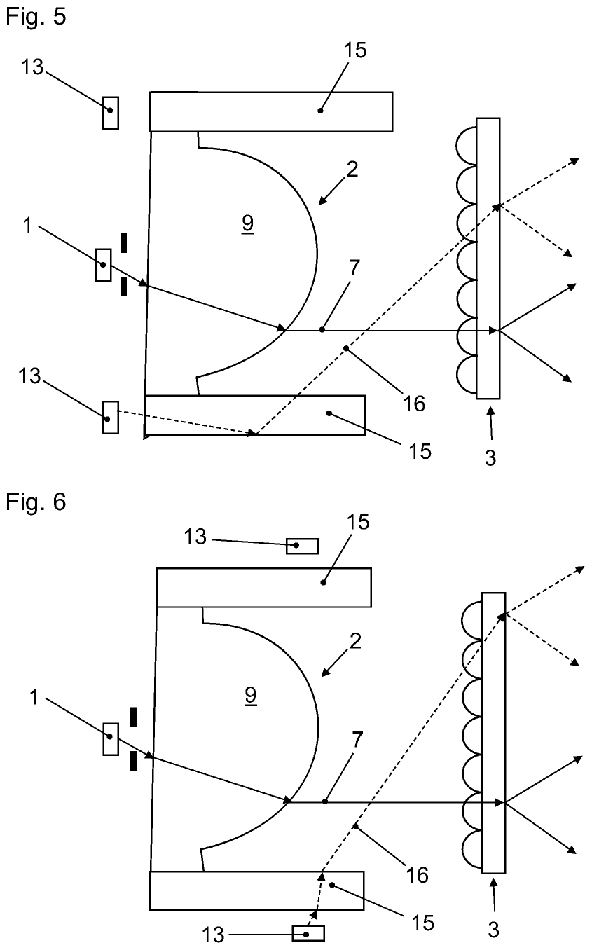

The fourth embodiment according to FIG. 6 is essentially the same as the third embodiment. In this embodiment, too, light guides 15 are provided which extend to the right in FIG. 6 in the direction of the secondary optics 3. However, in the fourth embodiment, the second light sources 13 are arranged laterally on separate printed circuit boards not shown, similar to the second embodiment. The light 16 emitted by the second light sources 13 enters the light guides 15 laterally from the outside and exits them inwardly directly toward the secondary optics 3.

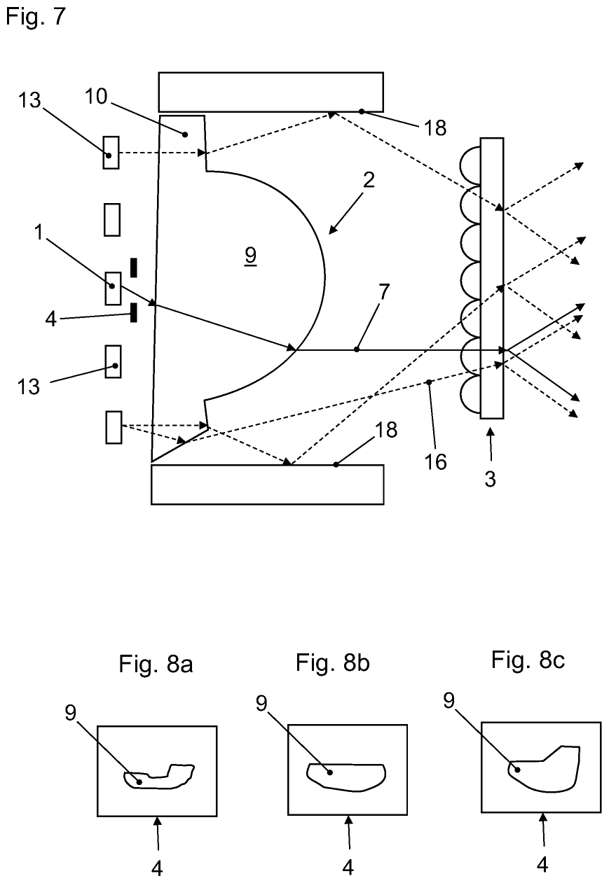

In the fifth embodiment according to FIG. 7, the second light sources 13 are arranged together with the first light sources 1 on a common printed circuit board 5 (not shown in FIG. 7). However, in contrast to the third embodiment, the second light sources 13 are arranged further inward, so that their light 16 enters the primary optics 2 directly. The circumferential edge 10 of the lenses 9 of the primary optics 2 has inclined surfaces in the fifth embodiment.

Instead of the light guides provided in the third and fourth embodiments, the headlight in the fifth embodiment includes reflective surfaces 18 that can reflect light 16 deflected upward and downward from the primary optics 2 toward the secondary optics 3.

List of reference signs:
1 First light source
2 Primary optics
3 Secondary optics
4 Aperture stop
5 Printed circuit board
6 Heat sink
7 Light emitted from the first light source
8 Aperture opening of the aperture stop
9 Primary optics lens
10 Circumferential edge of the lens
11 Cylindrical lens array
12 Cylindrical lens of the cylindrical lens array
13 Second light source
14 Reflecting surface
15 Light guide
16 Light emitted from the second light source
17 Printed circuit board for the second light source
18 reflecting surface

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlamp for a motor vehicle, comprising:
at least one first light source,
at least one aperture stop,
a primary optics, and
a secondary optics,
wherein the headlamp is arranged such that the light emanating from the at least one first light source passes at least partially through the aperture stop, the primary optics and the secondary optics in succession to produce a main light function,
wherein the headlamp further comprises at least one second light source and is arranged such that the light emanating from the at least one second light source passes at least partially through the primary optics or the secondary optics for generating a signal light function.

2. The headlamp according to claim 1, wherein the primary optics comprise at least one lens for imaging the aperture stop into the exterior space of the motor vehicle, the lens being a collimating lens.

3. The headlamp according to claim 2, wherein the headlamp is arranged such that the light emanating from the at least one first light source passes through the at least one lens for generating a main light function and that the light emanating from the at least one second light source passes at least partially through the at least one lens for generating a signal light function.

4. The headlamp according to claim 1, wherein the secondary optics comprises a cylindrical lens array.

5. The headlamp according to claim 4, wherein the cylindrical axes of the cylindrical lenses of the cylindrical lens array are oriented vertically when the headlamp is installed in a motor vehicle.

6. The headlamp according to claim 4, wherein the headlamp is arranged such that light emanating from the at least one first light source passes through the cylindrical lens array to produce a main light function and such that light emanating from the at least one second light source passes at least partially through the cylindrical lens array to produce a signal light function.

7. The headlamp according to claim 1, wherein the at least one first light source is a light emitting diode arranged on a printed circuit board or the at least one second light source is a light emitting diode arranged on a printed circuit board.

8. The headlamp according to claim 1, wherein the at least one first light source is configured as a light emitting diode and the at least one second light source is configured as a light emitting diode, and wherein the at least one first light source and the at least one second light source are arranged on a common printed circuit board.

9. The headlamp according to claim 1, wherein the headlamp comprises a first heat sink associated with the at least one first light source and the headlamp comprises a second heat sink associated with the at least one second light source.

10. The headlamp according to claim 9, wherein the first heat sink associated with the at least one first light source and the second heat sink associated with the at least one second light source are identical.

11. The headlamp according to claim 1, wherein the headlamp comprises at least one light guide having an entrance surface and an exit surface, the headlamp being arranged for the light emitted by the at least one second light source to enter the entrance surface of the at least one light guide to exit the exit surface of the at least one light guide and to subsequently pass at least partially through the primary optics or the secondary optics.

12. The headlamp according to claim 11, wherein the headlamp is arranged for the light to emerge from the at least one second light source in a direction towards the entrance surface of the at least one light guide.

13. The headlamp according to claim 11, wherein the headlamp comprises at least one reflecting surface the headlamp being arranged for the light to emerge from the at least one second light source in the direction of the at least one reflecting surface and to be reflected by the at least one reflecting surface onto the entrance surface of the at least one light guide or onto the secondary optics.

14. The headlamp according to claim 1, wherein the main light function is a high beam and/or a low beam.

15. The headlamp according to claim 1, wherein the signal light function is a daytime running light and/or a position light.
